(19) United States
(12) Patent Application Publication
(10) Pub. No.: US 2006/0208659 A1
(43) Pub. Date: Sep. 21, 2006

(54) Drive device for lighting equipment

(75) Inventor: Kiyoshi Okishima, Kanagawa (JP)

Correspondence Address: Patrick G. Burns;GREER, BURNS & CRAIN, LTD., Suite 2500, 300 South Wacker Drive, Chicago, IL, 60606, US

(73) Assignee: SANYO TECNICA CO., LTD.

(21) Appl. No.: 11/374,346

(22) Filed: Mar. 13, 2006

(30) Foreign Application Priority Data
Mar. 15, 2005 (JP) 2005-73163

(51) Int. Cl. H05B 37/00

(52) U.S. Cl. 315/205

(57) ABSTRACT

A drive device for lighting equipment includes a rectifier circuit 2 that rectifies an output current of an alternating-current generator 1; a voltage converter circuit 3 that steps up or down a DC voltage of the rectifier circuit 2 to a predetermined voltage; and a semiconductor light-emitting device 51 that is driven by an output voltage of the voltage converter circuit 3.

### BACKGROUND OF THE INVENTION

1. Field of the Invention

The present invention relates to a drive device for lighting equipment which uses a semiconductor light-emitting device (LED) and which is mounted on a bicycle, for example. In particular, the present invention relates to a drive device for lighting equipment, which is suitable for a light of, for example, a bicycle which uses a generator as a supply energy source.

2. Description of the Related Art

Conventionally, a filament electric lamp is used for a headlight of a bicycle. On the other hand, the practical use of a semiconductor light-emitting device (LED) which provides the same brightness as a filament electric lamp with power consumption reduced by about ⅓ or less, is proceeding. A bicycle generator uses the rotational movement of a wheel as its energy source. In a conventional electric lamp system, a generator is directly connected to a lighting electric lamp and energy from the generator is supplied to the lighting electric lamp. Thus, the energy supplied to the lighting electric lamp depends on the rotational movement of the wheel. In the case in which the number of rotations is small, the case, for example, in which the bicycle is traveling at a low speed, the electric lamp does not provide high-brightness light emission. To overcome such a problem, battery powered lighting equipment is also available.

In the battery powered lighting equipment, however, the batteries need to be changed or charged, causing a drawback such as poor usability. In addition, there are drawbacks in that the electric lamp requires a power consumption of 3 (W) to 6 (W) and needs to be replaced as the electric lamp is a consumable item.

As a solution to overcome the problem of insufficient illuminance caused when the bicycle is traveling at a low speed, there is a known technique such as the one disclosed in Japanese unexamined Patent Publication (KOKAI) No. 2000-62523 (see page 1, Abstract).

In a lighting control device for a bicycle electric lamp disclosed in the above mentioned Japanese Patent Publication, an output of a generator is rectified and converted into a constant DC voltage by a constant-voltage circuit, and then, the voltage is supplied to a lighting electric lamp, causing the electric lamp to emit light. In the above mentioned Patent Publication, however, a capacitor is provided which is charged while the bicycle is traveling at a high speed. When the bicycle is traveling at a low speed, the charge charged in the capacitor is discharged, causing the electric lamp to emit light.

The above-described device, however, has a drawback in that since the power consumption of the electric lamp is huge the electric lamp cannot emit light for an extended period of time.

### SUMMARY OF THE INVENTION

The present invention is made in view of the aforementioned problems. An object of the present invention is to provide a novel drive device for lighting equipment that enables high-brightness light emission for an extended period of time even when the traveling speed of a bicycle is as low as a normal speed at which a person walks.

To attain the above object, the present invention employs the following technical configuration.

A first aspect of the present invention is a drive device for lighting equipment comprising: a rectifier circuit that rectifies an output current of an alternating-current generator; a voltage converter circuit that steps up or down a DC voltage of the rectifier circuit to a predetermined voltage; and a semiconductor light-emitting device that is driven by an output voltage of the voltage converter circuit.

A second aspect of the present invention is a drive device for lighting equipment comprising: a rectifier circuit that converts an alternating current into a direct current; a voltage converter circuit that steps up or down a DC voltage of the rectifier circuit to a predetermined voltage; and a semiconductor light-emitting device that is driven by an output voltage of said voltage converter circuit.

According to the present invention, since light with sufficient brightness is emitted in a wide speed range of about 3 to 16 km/h, good usability is achieved. Particularly, at a speed of 3 to 4 km/h which is a normal speed at which a person walks, sufficient brightness can be obtained only with a generator.

While the power consumption of the conventional electric lamp is 3.0 (W) or 6.0 (W), a semiconductor light-emitting device (LED) has a rated voltage of 10 V and a current of 60 mA. Even when two semiconductor light-emitting devices are used, the power consumption is 1.2 W and thus is reduced by about 20% to 40% over the conventional electric lamp, achieving power savings. Along with the power savings, the electric generating capability of a generator may be reduced, whereby miniaturization is made possible. In this case, an advantageous effect is provided that the pedal force which is the force that presses a pedal becomes light.

Moreover, since consumable items such as batteries are not used, the device can be used semipermanently, resulting in providing an environmentally-friendly device.

### BRIEF DESCRIPTION OF THE DRAWINGS

FIG.1 is a circuit diagram showing a configuration of a drive device for lighting equipment of the present invention;

FIG. 2 is a diagram showing a relationship between the speed of a bicycle and a generated voltage of a generator;

FIG. 3 is a diagram showing a relationship between the speed of the bicycle and a LED drive voltage; and

FIG. 4 is a diagram showing relationships between the speed of the bicycle and the generated voltage, the rectified voltage of the generator and a LED drive voltage, respectively.

### DESCRIPTION OF THE PREFERRED EMBODIMENT

An embodiment of the present invention will now be described with reference to the drawings.

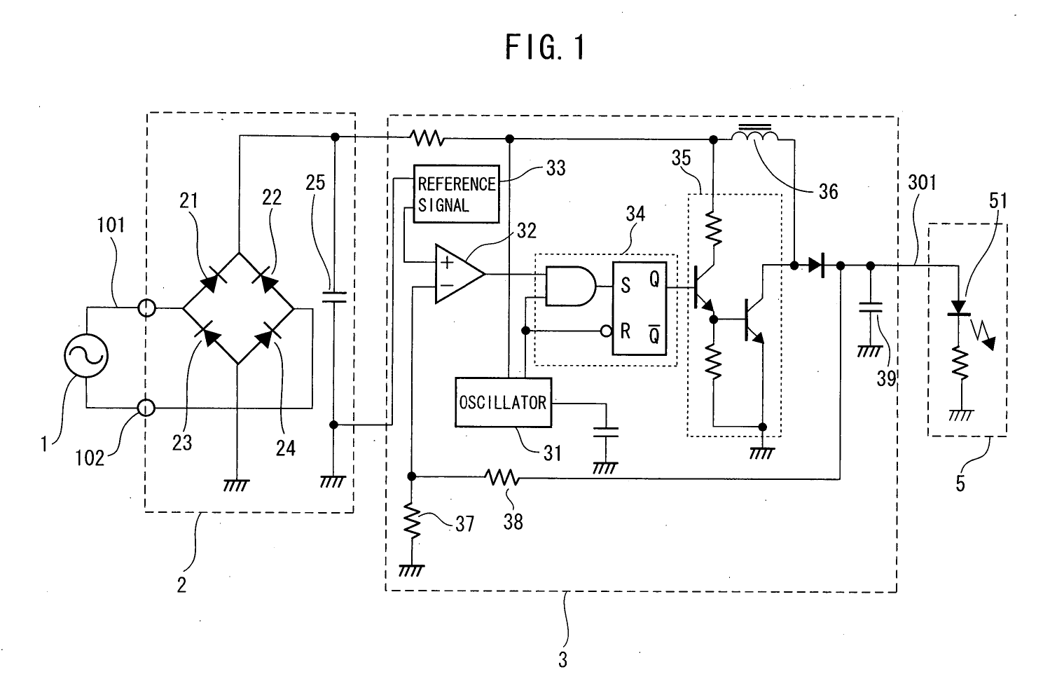

FIG.1 is a circuit diagram showing a configuration of a drive device for lighting equipment according to an embodiment of the present invention.

In a drive device for lighting equipment of the present invention, an output current of a generator 1 is rectified by a rectifier circuit 2 into a DC voltage, the DC voltage is stepped up by a step-up circuit 3, and using the stepped up voltage a semiconductor light-emitting device (LED) 51 is caused to emit light.

Now, the drive device for lighting equipment of the present invention will be described in detail.

FIG. 1 is a circuit diagram showing a configuration of the drive device for lighting equipment according to the embodiment of the present invention.

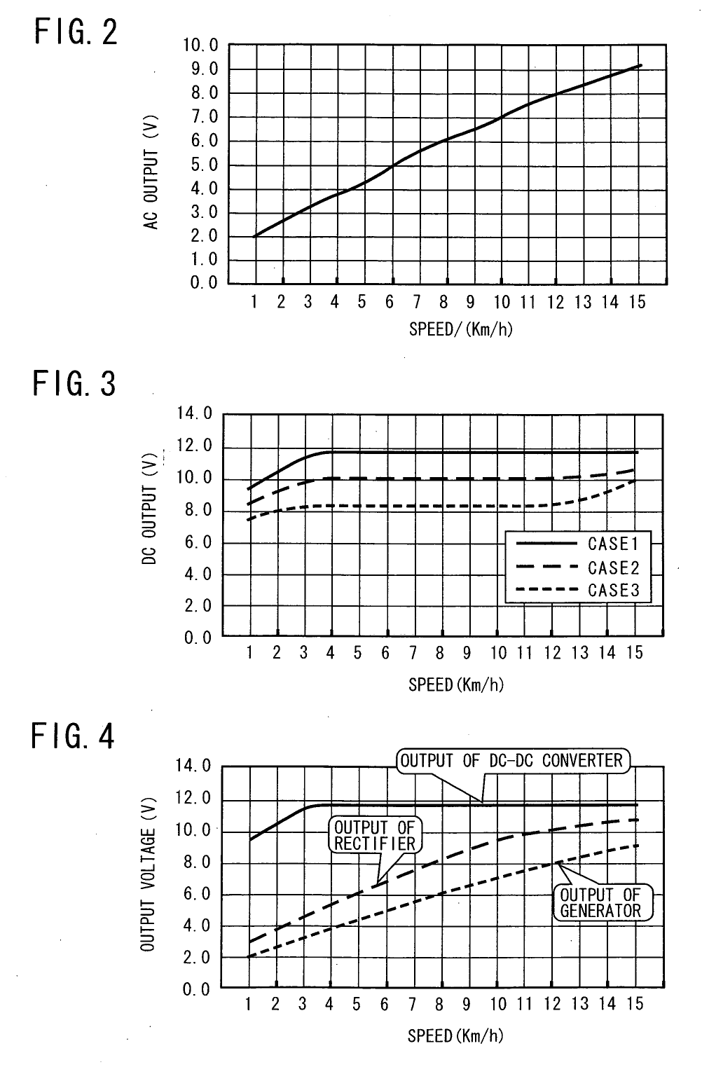

In FIG. 1, reference numeral 1 denotes a generator mounted on a bicycle. The generator 1 uses the rotation of a wheel of the bicycle as its energy source. The generator 1 can employ several methods: for example, a method in which a roller is brought into contact with a tire and a magnet is caused to rotate to induce an electromotive force; and a method called the “hub dynamo” in which a magnet is mounted on a hub of a wheel and thereby an electromotive force is obtained. In either method, the rotational movement energy of the wheel of the bicycle is converted into alternating-current electrical energy. In many cases, the generator 1 outputs an alternating-current output voltage of 3 to 9 (V) and has a power of 3 to 6 (W). The electromotive force is, as shown in FIG. 2, roughly proportional to the traveling speed of the bicycle. In an example of FIG. 2, the alternating-current output voltage is 3 (V) at a speed of 3 km/h, 7 (V) at a speed of 10 km/h, and 9 (V) at a speed of 15 km/h. This shows the voltage between the lines 101 and 102 of FIG. 1. This alternating-current voltage is rectified by a bridge circuit composed of rectifier diodes 21, 22, 23, and 24 in the rectifier circuit 2, and converted into a DC voltage of 4 (V) to 11 (V) by a smoothing effect of a smoothing capacitor 25. The “output of rectifier” in a graph of FIG. 4 shows this state.

Reference numeral 3 denotes a DC-DC converter circuit. The DC-DC converter circuit 3 steps up a DC voltage of 4 to 11 (V) which is the output of the rectifier circuit 2 to a DC voltage of 12 (V), and also outputs a constant voltage even if there are fluctuations in input voltage.

The DC-DC converter circuit 3 employs a system in which at least one terminal of an inductance 36 are short-circuited and opened, i.e., switched, to store charge in a capacitor 39 and a voltage is stepped up to a predetermined voltage. A control method for stable step-up voltage is such that by changing the pulse width for switching the amount of charge to be provided to the inductance 36 is controlled. In the drawing, reference numeral 31 denotes an oscillation circuit which generates a pulse signal of several hundred KHz. Reference numeral 34 denotes a RS flip-flop circuit that controls the pulse number. The RS flip-flop circuit 34 intermittently controls the oscillation pulse number based on an instruction from a comparator 32. The intermitting timing is such that a comparison is made between a reference voltage, which is the output voltage of a reference signal generating circuit 33, and a final output voltage generated in a line 301 and control is performed. The output voltage of the line 301 is determined by the ratio of resistors 37 and 38. FIG. 3 is a diagram showing a relationship between the speed of the bicycle and a LED drive voltage for the case in which the ratio of the resistors 37 and 38 is changed. In the present invention, as shown in FIG. 3, a constant output voltage is obtained in a wide bicycle speed range of about 3 to 15 km/h.

Reference numeral 5 denotes a light emitting portion in which a light-emitting diode (LED) 51 is caused to emit light by a drive voltage of the line 301.

Accordingly, as described above, even when the bicycle is traveling at a low speed, the light-emitting diode (LED) 51 is always driven at a predetermined voltage and thus the light-emitting diode (LED) 51 can continuously provide high-brightness light emission.

In the above description, the DC-DC converter circuit 3 is described in the case in which the output voltage of the rectifier circuit 2 is stepped up; on the other hand, in the case in which the generator 1 outputs a high voltage, a voltage obtained by stepping down the output voltage of the rectifier circuit 2 by the DC-DC converter circuit 3 is output to the line 301.

Although the above description exemplifies the use of a single light-emitting diode, the same functionality can be realized, even if a plurality of light-emitting diodes are used.

What is claimed is:

1. A drive device for lighting equipment comprising:
a rectifier circuit that rectifies an output current of an alternating-current generator;
a voltage converter circuit that steps up or down a DC voltage of said rectifier circuit to a predetermined voltage; and
a semiconductor light-emitting device that is driven by an output voltage of said voltage converter circuit.

2. A drive device for lighting equipment comprising:
a rectifier circuit that converts an alternating current into a direct current;
a voltage converter circuit that steps up or down a DC voltage of said rectifier circuit to a predetermined voltage; and
a semiconductor light-emitting device that is driven by an output voltage of said voltage converter circuit.
